(19) United States
(12) Patent Application Publication
(10) Pub. No.: US 2025/0156873 A1
(43) Pub. Date: May 15, 2025

(54) SYSTEM AND METHOD FOR FRAUD VERIFICATION ACROSS USER IDENTIFICATION FORMATS IMPLEMENTING SCANNING TECHNOLOGIES

(71) Applicant: JPMorgan Chase Bank, N.A., New York, NY (US)

(72) Inventors: Vijay Kumar PERLA, Westerville, OH (US); Kumar Rao KRISHNAGI, Powell, OH (US); Suresh MADHAVAN, Edison, NJ (US); Goran LONCARIC, Frisco, TX (US); Sivakumar NAGARAJAN, Lewis Center, DE (US); Dean ZHANG, Lewis Center, DE (US); Svitlana PRYYMACHUK, Columbus, OH (US); Kazi KHAN, Powell, DE (US)

(73) Assignee: JPMorgan Chase Bank, N.A., New York, NY (US)

(21) Appl. No.: 18/509,710

(22) Filed: Nov. 15, 2023

(51) Int. Cl. G06Q 20/40; G06F 9/54

(52) U.S. Cl. CPC G06Q 20/4016; G06F 9/547; G06Q 20/4014

(57) ABSTRACT

Various methods and processes, apparatuses/systems, and media for fraud verification across user identification formats are disclosed. A processor generates a digital image of an identification document presented by a customer; transmits the digital image to a server; calls a first API to read the digital image from the server and requests validation of the digital image with a second API; calls the second API to transmit the digital image to an SaaS; receives, by the second API, an identification validation response from the SaaS using existing data corresponding to the customer; implements an AI/ML model to generate a confidence score based on predefined rules and historical data; determines that the confidence score is equal to or more than a configurable threshold value; and validates the digital image based on determining that the confidence score is equal to or more than the configurable threshold value.

### TECHNICAL FIELD

This disclosure generally relates to data processing and identity verification, and, more particularly, to methods and apparatuses for implementing a platform, language, cloud, and database agnostic improved identification verification module configured for fraud verification across user identification formats implementing scanning technologies.

### BACKGROUND

Identify verification is an essential step in limiting transactions initiated by an unauthorized users at a branch office of a financial corporation (i.e., bank). In general, large enterprises, corporations, agencies, institutions, and other organizations are facing a continuing problem of dealing with fraudsters trying to conduct transaction using counterfeit identifiers (IDs).

For example, it is estimated that fraudsters impersonating as customers in branches of a large financial corporation by using counterfeit IDs may lead to tens of millions of dollars in losses every year. Typically, to address the issue, branch operations team may implement plans to invest to deploy purpose made scanning devices and services on bankers' desktops to validate IDs customers present. However, this approach may prove to be extremely costly. For example, a large financial corporation may include thousands of branches. Each branch may need three to four of such scanning devices for ID validation purposes. Thus, it is estimated that such large financial corporation may need to invest tens of millions of dollars to implement such scanning devices. Moreover, such implementation of scanning devices may also prove to be time consuming. It is estimated to take a couple of years for a large financial corporation to implement (i.e., integration into banker tools and deployment) these devices.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic improved identification verification module configured for fraud verification across user identification formats implementing scanning technologies, but the disclosure is not limited thereto.

According to exemplary embodiments, a method for fraud verification across user identification formats by utilizing one or more processors along with allocated memory is disclosed. The method may include: scanning an identification document presented by a customer at a branch office by utilizing a scanning device; generating, in response to scanning, a digital image of the identification document; transmitting the digital image to a server; calling a first application programing interface (API) to read the digital image from the server and request validation of the digital image with a second API for fraud verification across user identification formats; calling the second API to transmit the digital image to a Software as a Service (Saas); receiving, by the second API, an identification validation response from the SaaS using existing data corresponding to the customer; implementing an Artificial Intelligence (AI)/Machine Learning (ML) model to generate a confidence score based on predefined rules and historical data; determining that the confidence score is equal to or more than a configurable threshold value; and validating the digital image based on determining that the confidence score is equal to or more than the configurable threshold value.

According to exemplary embodiments, the scanning device may be a printer located at the branch office.

According to exemplary embodiments, the server may be an electronic mail server shared by a plurality of users at the branch office.

According to exemplary embodiments, the second API may be an Identification Verification as a Service API.

According to exemplary embodiments, the method may further include: receiving the existing data from a database that stores the existing data that includes profile information data corresponding to the customer including first name, last name, home address, phone number, and email address, but the disclosure is not limited thereto.

According to exemplary embodiments, the method may further include: training the AI/ML model based on the historical data received from a plurality of data sources providing data corresponding to customer activity pattern data.

According to exemplary embodiments, the customer activity pattern data may include one or more of the following: data corresponding to whether the customer conducts transactions same branch where the scanning device is located or different branches; data corresponding to frequency of branch visits by the customer; type of transactions previously conducted by the customer, but the disclosure is not limited thereto.

According to exemplary embodiments, the SaaS may allow users at the branch to connect to and use cloud-based applications over the Internet.

According to exemplary embodiments, the method may further include: determining that the confidence score is less than the configurable threshold value; receiving additional verification documents from the customer; and training the AI/ML model with the additional verification documents to generate the confidence score.

According to exemplary embodiments, the method may further include: implementing an identification validation portal to read the identification validation response generated by the SaaS from a cloud based datastore.

According to exemplary embodiments, a system for fraud verification across user identification formats is disclosed. the system may include: a processor; and a memory operatively connected to the processor via a communication interface, the memory storing computer readable instructions, when executed, may cause the processor to: scan an identification document presented by a customer at a branch office by utilizing a scanning device; generate, in response to scanning, a digital image of the identification document; transmit the digital image to a server; call a first API to read the digital image from the server and request validation of the digital image with a second API for fraud verification across user identification formats; call the second API to transmit the digital image to an SaaS; receive, by the second API, an identification validation response from the SaaS using existing data corresponding to the customer; implement an AI/ML model to generate a confidence score based on predefined rules and historical data; determine that the confidence score is equal to or more than a configurable threshold value; and validate the digital image based on determining that the confidence score is equal to or more than the configurable threshold value.

According to exemplary embodiments, the processor may be further configured to: receive the existing data from a database that stores the existing data that includes profile information data corresponding to the customer including first name, last name, home address, phone number, and email address, but the disclosure is not limited thereto.

According to exemplary embodiments, the processor may be further configured to: train the AI/ML model based on the historical data received from a plurality of data sources providing data corresponding to customer activity pattern data.

According to exemplary embodiments, the processor may be further configured to: determine that the confidence score is less than the configurable threshold value; receive additional verification documents from the customer; and train the AI/ML model with the additional verification documents to generate the confidence score.

According to exemplary embodiments, the processor may be further configured to: implement an identification validation portal to read the identification validation response generated by the SaaS from a cloud based datastore.

According to exemplary embodiments, a non-transitory computer readable medium configured to store instructions for fraud verification across user identification formats is disclosed. The instructions, when executed, may cause a processor to perform the following: scanning an identification document presented by a customer at a branch office by utilizing a scanning device; generating, in response to scanning, a digital image of the identification document; transmitting the digital image to a server; calling a first API to read the digital image from the server and request validation of the digital image with a second API for fraud verification across user identification formats; calling the second API to transmit the digital image to an SaaS; receiving, by the second API, an identification validation response from the SaaS using existing data corresponding to the customer; implementing an Artificial Intelligence AI/ML model to generate a confidence score based on predefined rules and historical data; determining that the confidence score is equal to or more than a configurable threshold value; and validating the digital image based on determining that the confidence score is equal to or more than the configurable threshold value.

According to exemplary embodiments, the instructions, when executed, may cause the processor to further perform the following: receiving the existing data from a database that stores the existing data that includes profile information data corresponding to the customer including first name, last name, home address, phone number, and email address, but the disclosure is not limited thereto.

According to exemplary embodiments, the instructions, when executed, may cause the processor to further perform the following: training the AI/ML model based on the historical data received from a plurality of data sources providing data corresponding to customer activity pattern data.

According to exemplary embodiments, the instructions, when executed, may cause the processor to further perform the following: determining that the confidence score is less than the configurable threshold value; receiving additional verification documents from the customer; and training the AI/ML model with the additional verification documents to generate the confidence score.

According to exemplary embodiments, the instructions, when executed, may cause the processor to further perform the following: implementing an identification validation portal to read the identification validation response generated by the SaaS from a cloud based datastore.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic improved identification verification module configured for fraud verification across user identification formats implementing scanning technologies in accordance with an exemplary embodiment.

FIG. 2 illustrates an exemplary diagram of a network environment with a platform, language, database, and cloud agnostic improved identification verification device in accordance with an exemplary embodiment.

FIG. 3 illustrates a system diagram for implementing a platform, language, database, and cloud agnostic improved identification verification device having a platform, language, database, and cloud agnostic improved identification verification module in accordance with an exemplary embodiment.

FIG. 4 illustrates a system diagram for implementing a platform, language, database, and cloud agnostic improved identification verification module of FIG. 3 in accordance with an exemplary embodiment.

FIG. 5 illustrates an exemplary architecture diagram implemented by the platform, language, database, and cloud agnostic improved identification verification module of FIG. 4 for fraud verification across user identification formats implementing scanning technologies in accordance with an exemplary embodiment.

FIG. 6 illustrates an exemplary flow chart of a process implemented by the platform, language, database, and cloud agnostic improved identification verification module of FIG. 4 for fraud verification across user identification formats implementing scanning technologies in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

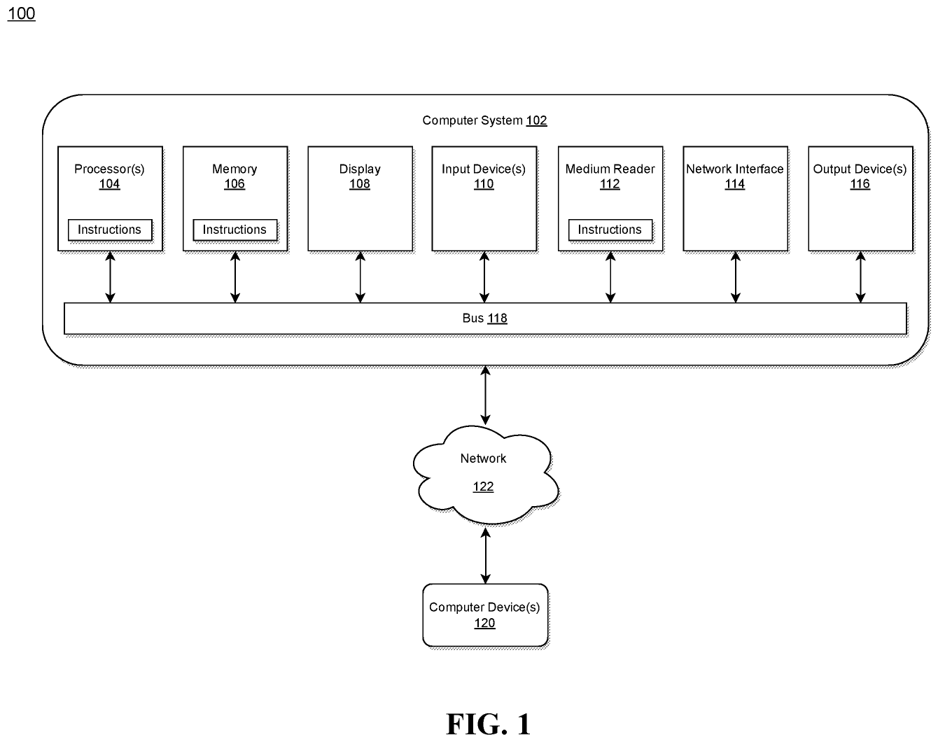

FIG. 1 is an exemplary system 100 for use in implementing a platform, language, database, and cloud agnostic improved identification verification module configured to automate improved identification verification through AI for cloud infrastructure environments fraud verification across user identification formats implementing scanning technologies in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the improved identification verification module implemented by the system 100 may be platform, language, database, and cloud agnostic that may allow for consistent easy orchestration and passing of data through various components to output a desired result regardless of platform, browser, language, database, and cloud environment. Since the disclosed process, according to exemplary embodiments, is platform, language, database, browser, and cloud agnostic, the improved identification verification module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

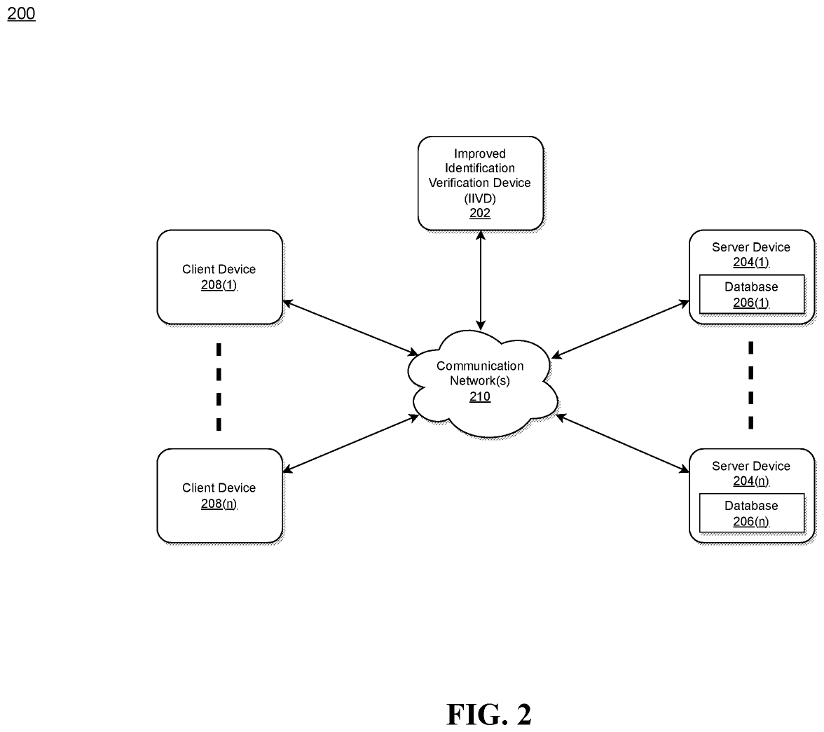

Referring to FIG. 2, a schematic of an exemplary network environment 200 for implementing a language, platform, database, and cloud agnostic improved identification verification device (IIVD) of the instant disclosure is illustrated.

According to exemplary embodiments, the above-described problems associated with conventional tools may be overcome by implementing an IIVD 202 as illustrated in FIG. 2 that may be configured for implementing a platform, language, database, and cloud agnostic improved identification verification module configured to automate improved identification verification through Generative AI for cloud infrastructure environments described as code, but the disclosure is not limited thereto.

For example, according to exemplary embodiments, the above-described problems associated with conventional tools may be overcome by implementing an IIVD 202 as illustrated in FIG. 2 that may be configured for implementing a platform, language, database, and cloud agnostic improved identification verification module configured to dynamically and automatically verify fraud across identification formats implementing scanning technologies, thereby modifying scanning devices, shortening deployment duration, enabling realization of large fraud loss savings must faster than compared to conventional solutions, but the disclosure is not limited thereto.

The IIVD 202 may have one or more computer system 102s, as described with respect to FIG. 1, which in aggregate provide the necessary functions.

The IIVD 202 may store one or more applications that can include executable instructions that, when executed by the IIVD 202, cause the IIVD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IIVD 202 itself, may be located in virtual server(s) running in a cloud-based computing environment rather than being tied to one or more specific physical network computing devices. Also, the application(s) may be running in one or more virtual machines (VMs) executing on the IIVD 202. Additionally, in one or more embodiments of this technology, virtual machine(s) running on the IIVD 202 may be managed or supervised by a hypervisor.

In the network environment 200 of FIG. 2, the IIVD 202 is coupled to a plurality of server devices 204(1)-204(n) that hosts a plurality of databases 206(1)-206(n), and also to a plurality of client devices 208(1)-208(n) via communication network(s) 210. A communication interface of the IIVD 202, such as the network interface 114 of the computer system 102 of FIG. 1, operatively couples and communicates between the IIVD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IIVD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IIVD 202 may be a standalone device or integrated with one or more other devices or apparatuses, such as one or more of the server devices 204(1)-204(n), for example. In one particular example, the IIVD 202 may be hosted by one of the server devices 204(1)-204(n), and other arrangements are also possible. Moreover, one or more of the devices of the IIVD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IIVD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the IIVD 202 that may efficiently provide a platform for implementing a platform, language, database, and cloud agnostic improved identification verification module configured to dynamically and automatically verify fraud across identification formats implementing scanning technologies, thereby modifying scanning devices, shortening deployment duration, enabling realization of large fraud loss savings must faster than compared to conventional solutions, but the disclosure is not limited thereto.

The client devices 208(1)-208(n) may run interface applications, such as standard web browsers or standalone client applications, which may provide an interface to communicate with the IIVD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the IIVD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the IIVD 202, the server devices 204(1)-204(n), or the client devices 208(1)-208(n), for example, may be configured to operate as virtual instances on the same physical machine. For example, one or more of the IIVD 202, the server devices 204(1)-204(n), or the client devices 208(1)-208(n) may operate on the same physical device rather than as separate devices communicating through communication network(s) 210. Additionally, there may be more or fewer IIVDs 202, server devices 204(1)-204(n), or client devices 208(1)-208(n) than illustrated in FIG. 2. According to exemplary embodiments, the IIVD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

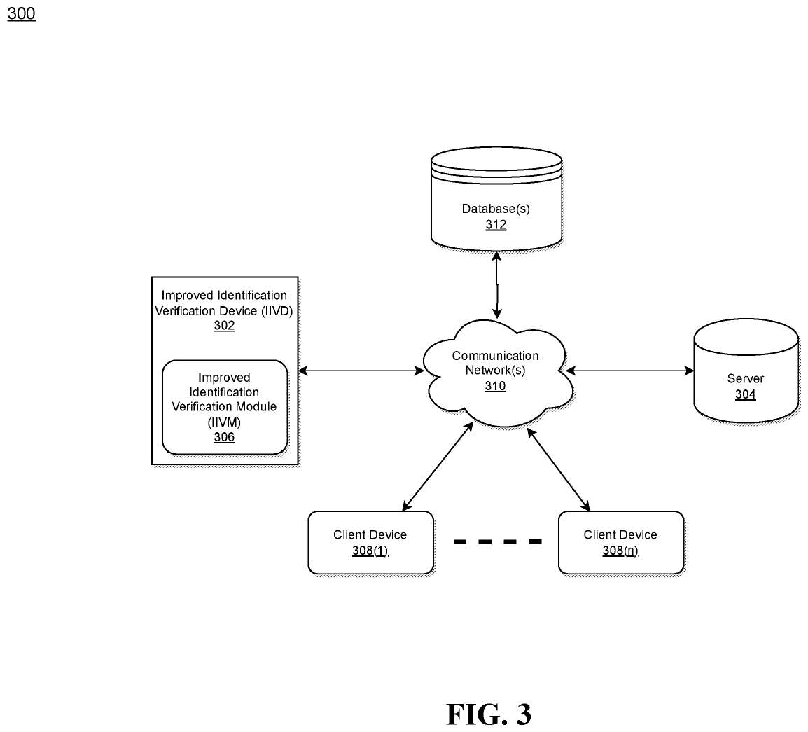

FIG. 3 illustrates a system diagram for implementing a platform, language, and cloud agnostic IIVD having a platform, language, database, and cloud agnostic improved identification verification module (IIVM) in accordance with an exemplary embodiment.

As illustrated in FIG. 3, the system 300 may include an IIVD 302 within which an IIVM 306 is embedded, a server 304, a database(s) 312, a plurality of client devices 308(1) . . . 308(n), and a communication network 310.

According to exemplary embodiments, the IIVD 302 including the IIVM 306 may be connected to the server 304, and the database(s) 312 via the communication network 310. The IIVD 302 may also be connected to the plurality of client devices 308(1) . . . 308(n) via the communication network 310, but the disclosure is not limited thereto. The database(s) 312 may include rule database.

According to exemplary embodiment, the IIVD 302 is described and shown in FIG. 3 as including the IIVM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the IIVM 306 may be configured to receive real-time feed of data from the plurality of client devices 308(1) . . . 308(n) and secondary sources via the communication network 310.

As may be described below, the IIVM 306 may be configured to: scan an identification document presented by a customer at a branch office by utilizing a scanning device; generate, in response to scanning, a digital image of the identification document; transmit the digital image to a server; call a first API to read the digital image from the server and request validation of the digital image with a second API for fraud verification across user identification formats; call the second API to transmit the digital image to an SaaS; receive, by the second API, an identification validation response from the SaaS using existing data corresponding to the customer; implement an AI/ML model to generate a confidence score based on predefined rules and historical data; determine that the confidence score is equal to or more than a configurable threshold value; and validate the digital image based on determining that the confidence score is equal to or more than the configurable threshold value, but the disclosure is not limited thereto.

The plurality of client devices 308(1) . . . 308(n) are illustrated as being in communication with the IIVD 302. In this regard, the plurality of client devices 308(1) . . . 308(n) may be “clients” (e.g., customers) of the IIVD 302 and are described herein as such. Nevertheless, it is to be known and understood that the plurality of client devices 308(1) . . . 308(n) need not necessarily be “clients” of the IIVD 302, or any entity described in association therewith herein. Any additional or alternative relationship may exist between either or both of the plurality of client devices 308(1) . . . 308(n) and the IIVD 302, or no relationship may exist. For example, the client devices 308(1) . . . 308(n) may be utilized by bankers at a local branch office.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the IIVD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The IIVD 302 may be the same or similar to the IIVD 202 as described with respect to FIG. 2, including any features or combination of features described with respect thereto.

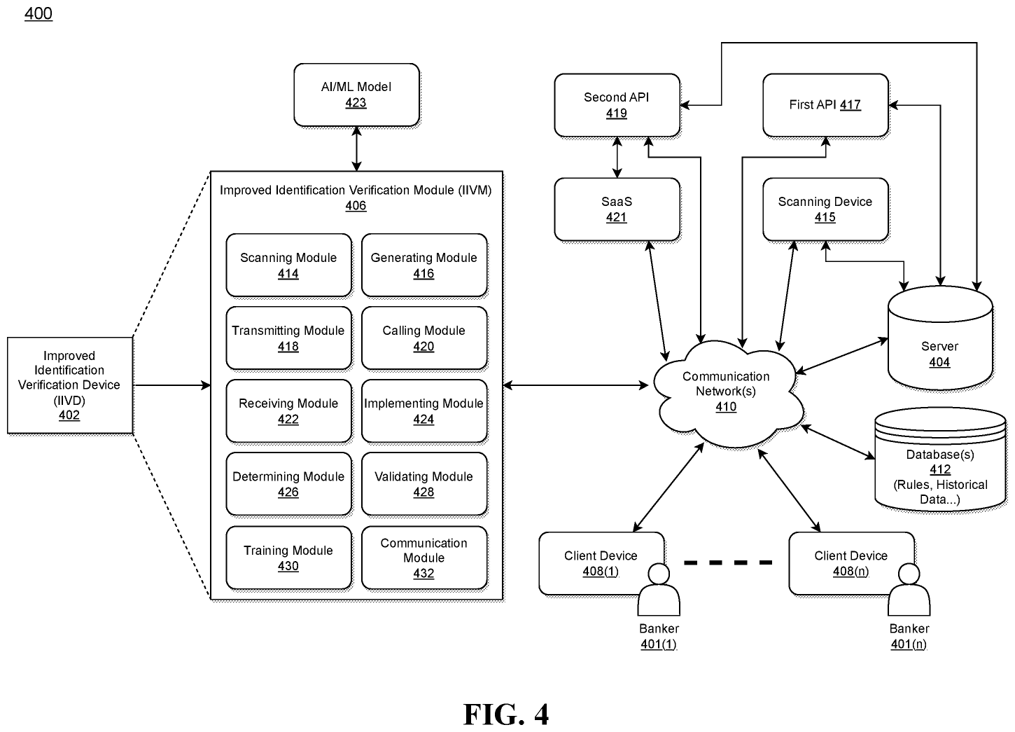

FIG. 4 illustrates a system diagram for implementing a platform, language, database, and cloud agnostic IIVM of FIG. 3 in accordance with an exemplary embodiment.

According to exemplary embodiments, the system 400 may include a platform, language, database, and cloud agnostic IIVD 402 within which a platform, language, database, and cloud agnostic IIVM 406 is embedded, a server 404, database(s) 412, and a communication network 410. According to exemplary embodiments, server 404 may comprise a plurality of servers located centrally or located in different locations, but the disclosure is not limited thereto. The client devices 408(1) . . . 408(n) may be utilized by bankers 401(1) . . . 401(n), respectively, at a local branch office, but the disclosure is not limited thereto.

According to exemplary embodiments, the IIVD 402 including the IIVM 406 may be connected to the server 404, the database(s) 412, scanning device 415, first API 417, SaaS 421, and second API 419 via the communication network 410. The IIVD 402 may also be connected to the plurality of client devices 408(1)-408(n) via the communication network 410, but the disclosure is not limited thereto. The IIVM 406, the server 404, the plurality of client devices 408(1)-408(n), the database(s) 412, the communication network 410 as illustrated in FIG. 4 may be the same or similar to the IIVM 306, the server 304, the plurality of client devices 308(1)-308(n), the database(s) 312, the communication network 310, respectively, as illustrated in FIG. 3. The client devices 408(1) . . . 408(n) may be utilized by bankers 401(1) . . . 401(n), respectively, at a local branch office, but the disclosure is not limited thereto. The IIVM 406 may also be connected to an AI/ML model 423 via the communication network 410.

According to exemplary embodiments, the data generated by the inventive concepts implemented by the IIVM 406 as disclosed herein can be shared with other downstream applications via API or data share algorithms for analytics and machine learning and business intelligence dashboards according to consumer work-load needs.

Details of the IIVM 406 is provided below with corresponding modules.

According to exemplary embodiments, as illustrated in FIG. 4, the IIVM 406 may include a scanning module 414, a generating module 416, a transmitting module 418, a calling module 420, a receiving module 422, an implementing module 424, a determining module 426, a validating module 428, a training module 430, and a communication module 432. According to exemplary embodiments, interactions and data exchange among these modules included in the IIVM 406 provide the advantageous effects of the disclosed invention. Functionalities of each module of FIG. 4 may be described in detail below with reference to FIGS. 4-6.

According to exemplary embodiments, each of the scanning module 414, generating module 416, transmitting module 418, calling module 420, receiving module 422, implementing module 424, determining module 426, validating module 428, training module 430, and the communication module 432 of the IIVM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the scanning module 414, generating module 416, transmitting module 418, calling module 420, receiving module 422, implementing module 424, determining module 426, validating module 428, training module 430, and the communication module 432 of the IIVM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the scanning module 414, generating module 416, transmitting module 418, calling module 420, receiving module 422, implementing module 424, determining module 426, validating module 428, training module 430, and the communication module 432 of the IIVM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the IIVM 406 of FIG. 4 may also be implemented by Cloud based deployment.

According to exemplary embodiments, each of the scanning module 414, generating module 416, transmitting module 418, calling module 420, receiving module 422, implementing module 424, determining module 426, validating module 428, training module 430, and the communication module 432 of the IIVM 406 of FIG. 4 may be called via corresponding API, but the disclosure is not limited thereto. For example, calls may also be made using Event based message interfaces in addition to APIs.

According to exemplary embodiments, the process implemented by the IIVM 406 may be executed via the communication module 432 and the communication network 410, which may comprise plural networks as described above. For example, in an exemplary embodiment, the various components of the IIVM 406 may communicate with the server 404, and the database(s) 412 via the communication module 432 and the communication network 410 and the results may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

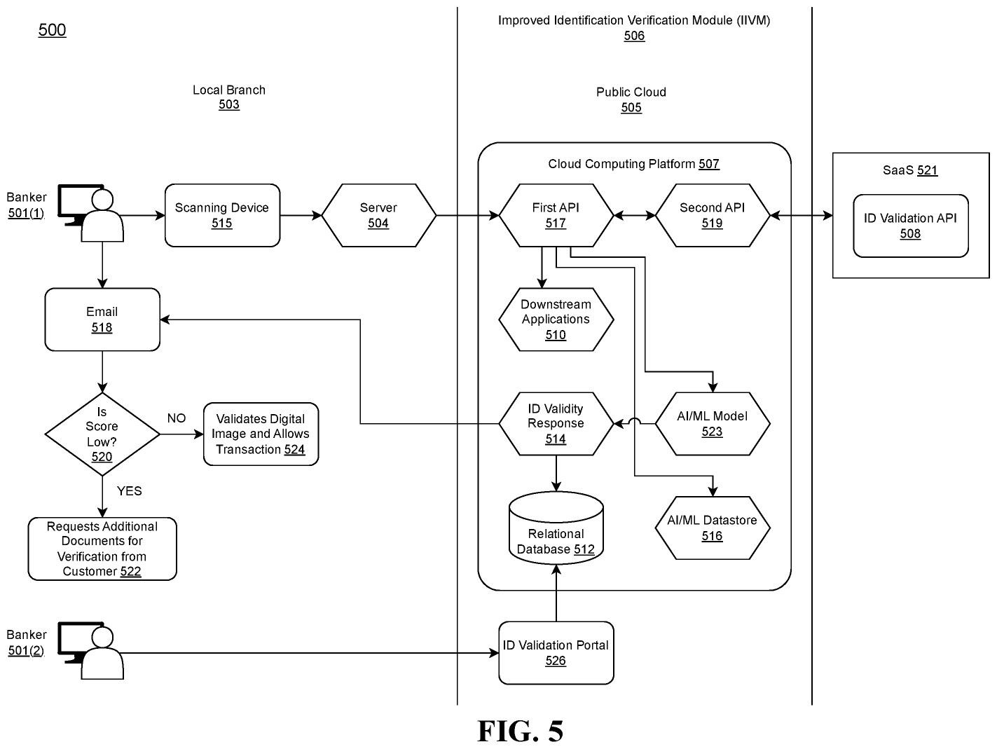

FIG. 5 illustrates an exemplary architecture diagram 500 implemented by the platform, language, database, and cloud agnostic IIVM 406 of FIG. 4 for fraud verification across user identification formats implementing scanning technologies in accordance with an exemplary embodiment.

As illustrated in FIG. 5, the exemplary architecture diagram 500 implemented by the platform, language, database, and cloud agnostic IIVM 406 of FIG. 4 may include a scanning device 515 operated by a banker 501(1) at a local branch 503. An IIVM 506 (same or similar to the IIVM 406) may be configured to be executable on a public cloud 505 environment that may include a cloud computing platform 507. The cloud computing platform 507 may include a first API 517 operatively connected to a second API 519. The cloud computing platform 507 may be operatively connected to a SaaS 521 which may include an ID validation API 508. The cloud computing platform 507 may be configured to host a plurality of downstream applications 510, a relational database 512 that may be operatively connected to an ID validation portal 526, an AI/ML model datastore 516, and an AI/ML model 523. ID validity response 514 generated based on the AI/ML model 523 may be stored onto the relational database 512 and sent to the banker 501(1)′ email 518.

According to exemplary embodiments, an exemplary workflow may include the following steps: 1) a customer walks into the local branch 503 to perform a wire transfer and banker 501(1) requesting Driving License (DL) from customer; 2) banker 501(1) walks to branch scanner, i.e., scanning device 515, and scans the DL; 3) DL image is sent to a email server, i.e., server 504; 4) the first API 517 reads the image from the email server, i.e., server 504, and request validation of image with the second API 519 (i.e., Identification Verification as a Service (IDVaaS) API); 5) IDVaaS API sends the image to the SaaS 521; 6) ID validity response 514 may be sent from the SaaS 521 to the IDVaaS API 519—after receiving response from the SaaS 521, the IDVaaS API performs customer information validation (i.e., first name, last name, address etc.); 7) the ID validity response 514 is sent to downstream applications 510 for consumption; 8) the ID Validity response 514 is also sent to the AI/ML model datastore 516; 9) API consumer makes a call to the AI/ML model 523 with the ID validity response 514 to obtain a model score; 10) the ID validity response 514 is then sent to the banker 501(1)'s email 518; 11) the ID validity response 514 may be saved to the relational database 512 for auditing purposes; 12) the banker 501(1) checks the email 518, and when it is determined that the model score is below a preconfigured threshold value, the banker 501(1) may request additional documents for verification from customer (block 522); 13) banker 501(1) or other bankers (i.e., 501(2)) may view all response in the ID validation portal 526. According to exemplary embodiments, when it is determined that the model score is equal to more than the preconfigured threshold value, the DL is validated, and transaction requested by the customer is allowed.

For example, referring back to FIGS. 4-5, the scanning module 414 may be configured to scan an identification document (i.e., driver's license, passport, state ID, etc., but the disclosure is not limited thereto) presented by a customer at a branch office (local branch 503) by utilizing a scanning device 415, 515. According to exemplary embodiments, the scanning device may be a printer or any other device that may be utilized to scan a document located at the branch office (local branch 503).

According to exemplary embodiments, the generating module 416 may be configured to generate, in response to scanning, a digital image of the identification document. The transmitting module 418 may be configured to transmit the digital image to a server 404, 504. According to exemplary embodiments, the server 404, 504 may be an electronic mail server shared by a plurality of users at the local branch 503.

The calling module 420 may be configured to call a first API 417, 517 to read the digital image from the server 404, 504 and request validation of the digital image with a second API 419, 519 for fraud verification across user identification formats.

According to exemplary embodiments, the calling module 420 may be further configured to call the second API 419, 519 to transmit the digital image to a SaaS 421, 521. The receiving module 422 may be configured to receive, by the second API 419, 519, an identification validation response (ID validity response 514) from the SaaS 421, 521 using existing data corresponding to the customer. According to exemplary embodiments, the second API 419, 519 may be an ID VaaS API, e.g., ID validation API 508 as illustrated in FIG. 5.

According to exemplary embodiments, the implementing module 424 may be configured to implement an AI/ML model 423, 523 to generate a confidence score based on predefined rules and historical data.

According to exemplary embodiments, the determining module 416 may be configured to determine that the confidence score is equal to or more than a configurable threshold value; and the validating module 428 may be configured to validate the digital image based on determining that the confidence score is equal to or more than the configurable threshold value.

According to exemplary embodiments, the receiving module 422 may be further configured to receive the existing data from a database 412 that stores the existing data that includes profile information data corresponding to the customer including first name, last name, home address, phone number, and email address, but the disclosure is not limited thereto.

According to exemplary embodiments, the processor may be further configured to train the AI/ML model 423, 523 based on the historical data received from a plurality of data sources providing data corresponding to customer activity pattern data.

According to exemplary embodiments, the customer activity pattern data may include one or more of the following: data corresponding to whether the customer conducts transactions same branch where the scanning device 415, 515 is located or different branches; data corresponding to frequency of branch visits by the customer; type of transactions previously conducted by the customer, but the disclosure is not limited thereto.

According to exemplary embodiments, the determining module 426 may be further configured to determine that the confidence score is less than the configurable threshold value. The receiving module 422 may be further configured to receive additional verification documents from the customer. The training muddle 430 may be configured to train the AI/ML model 423, 523 with the additional verification documents to generate the confidence score.

According to exemplary embodiments, the implementing module 424 may be further configured to implement an identification validation portal 526 (see FIG. 5) to read the identification validation response (i.e., the ID validity response 514) generated by the SaaS 421, 521 from a cloud based datastore, i.e., relational database 512. According to exemplary embodiments, the SaaS 421, 521 may allow users at the local branch 503 to connect to and use cloud-based applications over the Internet.

According to exemplary embodiment, the IIVM 406, 506 may implement cloud key management service for allowing centralized control over the cryptographic keys used to protect the data. This service may be integrated with other cloud-based services making it easier to encrypt data the banker 501(1) stores in these services and control access to the keys that decrypt it.

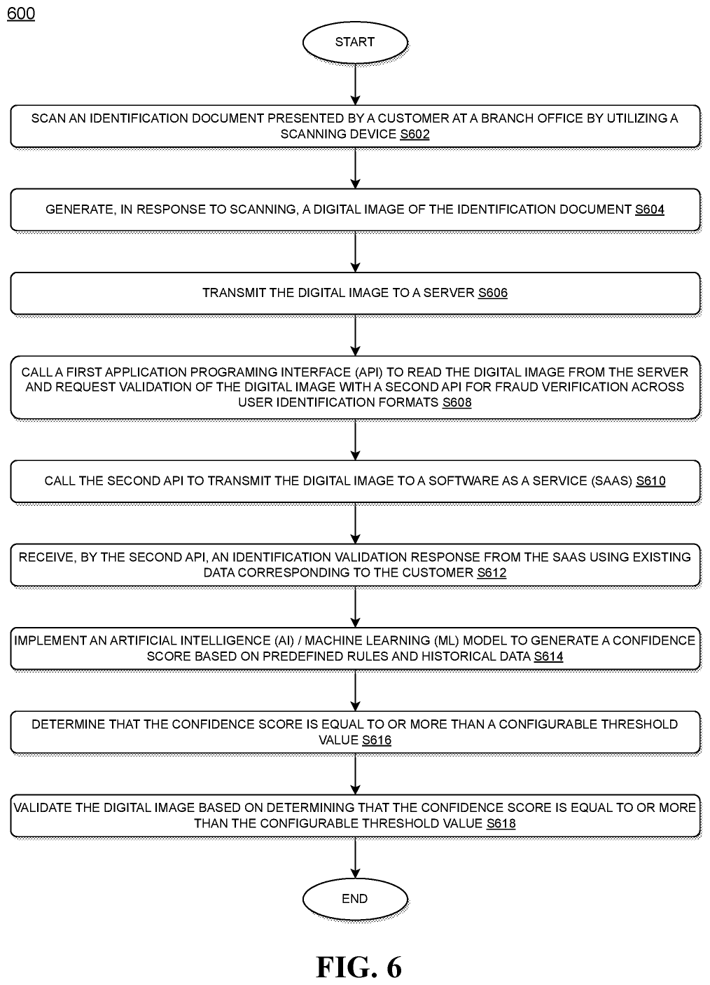

FIG. 6 illustrates an exemplary flow chart of a process 600 implemented by the platform, language, database, and cloud agnostic IIVM 406 of FIG. 4 for automating improved identification verification through fraud verification across user identification formats implementing scanning technologies in accordance with an exemplary embodiment in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include scanning an identification document presented by a customer at a branch office by utilizing a scanning device.

At step S604, the process 600 may include generating, in response to scanning, a digital image of the identification document.

At step S606, the process 600 may include transmitting the digital image to a server.

At step S608, the process 600 may include calling a first application API to read the digital image from the server and request validation of the digital image with a second API for fraud verification across user identification formats.

At step S610, the process 600 may include calling the second API to transmit the digital image to a SaaS.

At step S612, the process 600 may include receiving, by the second API, an identification validation response from the SaaS using existing data corresponding to the customer.

At step S614, the process 600 may include implementing an AI/ML model to generate a confidence score based on predefined rules and historical data.

At step S616, the process 600 may include determining that the confidence score is equal to or more than a configurable threshold value.

At step S618, the process 600 may include validating the digital image based on determining that the confidence score is equal to or more than the configurable threshold value.

According to exemplary embodiments, in the process 600, the scanning device may be a printer located at the branch office.

According to exemplary embodiments, in the process 600, the server may be an electronic mail server shared by a plurality of users at the branch office.

According to exemplary embodiments, in the process 600, the second API may be an Identification Verification as a Service API.

According to exemplary embodiments, the process 600 may further include: receiving the existing data from a database that stores the existing data that includes profile information data corresponding to the customer including first name, last name, home address, phone number, and email address, but the disclosure is not limited thereto.

According to exemplary embodiments, the process 600 may further include: training the AI/ML model based on the historical data received from a plurality of data sources providing data corresponding to customer activity pattern data.

According to exemplary embodiments, in the process 600, the customer activity pattern data may include one or more of the following: data corresponding to whether the customer conducts transactions same branch where the scanning device is located or different branches; data corresponding to frequency of branch visits by the customer; type of transactions previously conducted by the customer, but the disclosure is not limited thereto.

According to exemplary embodiments, in the process 600, the SaaS may allow users at the branch to connect to and use cloud-based applications over the Internet.

According to exemplary embodiments, the process 600 may further include: determining that the confidence score is less than the configurable threshold value; receiving additional verification documents from the customer; and training the AI/ML model with the additional verification documents to generate the confidence score.

According to exemplary embodiments, the process 600 may further include: implementing an identification validation portal to read the identification validation response generated by the SaaS from a cloud based datastore.

According to exemplary embodiments, the IIVD 402 may include a memory (e.g., a memory 106 as illustrated in FIG. 1) which may be a non-transitory computer readable medium that may be configured to store instructions for implementing a platform, language, database, and cloud agnostic IIVM 406 for fraud verification across user identification formats as disclosed herein. The IIVD 402 may also include a medium reader (e.g., a medium reader 112 as illustrated in FIG. 1) which may be configured to read any one or more sets of instructions, e.g., software, from any of the memories described herein. The instructions, when executed by a processor embedded within the IIVM 406, 506, or within the IIVD 402, may be used to perform one or more of the methods and processes as described herein. In a particular embodiment, the instructions may reside completely, or at least partially, within the memory 106, the medium reader 112, and/or the processor 104 (see FIG. 1) during execution by the IIVD 402.

According to exemplary embodiments, the instructions, when executed, may cause a processor embedded within the IIVM 406, 506, or the IIVD 402 to perform the following: scanning an identification document presented by a customer at a branch office by utilizing a scanning device; generating, in response to scanning, a digital image of the identification document; transmitting the digital image to a server; calling a first API to read the digital image from the server and request validation of the digital image with a second API for fraud verification across user identification formats; calling the second API to transmit the digital image to an SaaS; receiving, by the second API, an identification validation response from the SaaS using existing data corresponding to the customer; implementing an Artificial Intelligence AI/ML model to generate a confidence score based on predefined rules and historical data; determining that the confidence score is equal to or more than a configurable threshold value; and validating the digital image based on determining that the confidence score is equal to or more than the configurable threshold value. According to exemplary embodiments, the processor may be the same or similar to the processor 104 as illustrated in FIG. 1 or the processor embedded within the IIVD 202, IIVD 302, IIVD 402, and IIVM 406, 506, which is the same or similar to the processor 104.

According to exemplary embodiments, the instructions, when executed, may cause the processor 104 to further perform the following: receiving the existing data from a database that stores the existing data that includes profile information data corresponding to the customer including first name, last name, home address, phone number, and email address, but the disclosure is not limited thereto.

According to exemplary embodiments, the instructions, when executed, may cause the processor 104 to further perform the following: training the AI/ML model based on the historical data received from a plurality of data sources providing data corresponding to customer activity pattern data.

According to exemplary embodiments, the instructions, when executed, may cause the processor 104 to further perform the following: determining that the confidence score is less than the configurable threshold value; receiving additional verification documents from the customer; and training the AI/ML model with the additional verification documents to generate the confidence score.

According to exemplary embodiments, the instructions, when executed, may cause the processor to further perform the following: implementing an identification validation portal to read the identification validation response generated by the SaaS from a cloud based datastore.

According to exemplary embodiments as disclosed above in FIGS. 1-6, technical improvements effected by the instant disclosure may include a platform for implementing a platform, language, database, and cloud agnostic improved identification verification module configured for fraud verification across user identification formats implementing scanning technologies, but the disclosure is not limited thereto.

For example, according to exemplary embodiments as disclosed above in FIGS. 1-6, technical improvements effected by the instant disclosure may include a platform for implementing a platform, language, database, and cloud agnostic improved identification verification module configured to dynamically and automatically validate customer IDs and prevent fraud if invalidated, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for fraud verification across user identification formats by utilizing one or more processors along with allocated memory, the method comprising:
scanning an identification document presented by a customer at a branch office by utilizing a scanning device;
generating, in response to scanning, a digital image of the identification document;
transmitting the digital image to a server;
calling a first application programing interface (API) to read the digital image from the server and request validation of the digital image with a second API for fraud verification across user identification formats;
calling the second API to transmit the digital image to a Software as a Service (Saas);
receiving, by the second API, an identification validation response from the SaaS using existing data corresponding to the customer;
implementing an Artificial Intelligence (AI)/Machine Learning (ML) model to generate a confidence score based on predefined rules and historical data;
determining that the confidence score is equal to or more than a configurable threshold value; and
validating the digital image based on determining that the confidence score is equal to or more than the configurable threshold value.

2. The method according to claim 1, wherein the scanning device is a printer located at the branch office.

3. The method according to claim 1, wherein the server is an electronic mail server shared by a plurality of users at the branch office.

4. The method according to claim 1, wherein the second API is an Identification Verification as a Service API.

5. The method according to claim 1, further comprising:
receiving the existing data from a database that stores the existing data that includes profile information data corresponding to the customer including first name, last name, home address, phone number, and email address.

6. The method according to claim 1, further comprising:
training the AI/ML model based on the historical data received from a plurality of data sources providing data corresponding to customer activity pattern data.

7. The method according to claim 6, wherein the customer activity pattern data includes one or more of the following: data corresponding to whether the customer conducts transactions same branch where the scanning device is located or different branches; data corresponding to frequency of branch visits by the customer; type of transactions previously conducted by the customer.

8. The method according to claim 1, wherein the SaaS allows users at the branch to connect to and use cloud-based applications over the Internet.

9. The method according to claim 1, further comprising:
determining that the confidence score is less than the configurable threshold value;
receiving additional verification documents from the customer; and
training the AI/ML model with the additional verification documents to generate the confidence score.

10. The method according claim 1, further comprising:
implementing an identification validation portal to read the identification validation response generated by the SaaS from a cloud based datastore.

11. A system for fraud verification across user identification formats, the system comprising:
a processor; and
a memory operatively connected to the processor via a communication interface, the memory storing computer readable instructions, when executed, causes the processor to:
scan an identification document presented by a customer at a branch office by utilizing a scanning device;
generate, in response to scanning, a digital image of the identification document;
transmit the digital image to a server;
call a first application programing interface (API) to read the digital image from the server and request validation of the digital image with a second API for fraud verification across user identification formats;
call the second API to transmit the digital image to a Software as a Service (SaaS);
receive, by the second API, an identification validation response from the SaaS using existing data corresponding to the customer;
implement an Artificial Intelligence (AI)/Machine Learning (ML) model to generate a confidence score based on predefined rules and historical data;
determine that the confidence score is equal to or more than a configurable threshold value; and
validate the digital image based on determining that the confidence score is equal to or more than the configurable threshold value.

12. The system according to claim 11, wherein the scanning device is a printer located at the branch office.

13. The system according to claim 11, wherein the server is an electronic mail server shared by a plurality of users at the branch office.

14. The system according to claim 11, wherein the second API is an Identification Verification as a Service API.

15. The system according to claim 11, wherein the processor is further configured to:
receive the existing data from a database that stores the existing data that includes profile information data corresponding to the customer including first name, last name, home address, phone number, and email address.

16. The system according to claim 11, wherein the processor is further configured to:
train the AI/ML model based on the historical data received from a plurality of data sources providing data corresponding to customer activity pattern data.

17. The system according to claim 16, wherein the customer activity pattern data includes one or more of the following: data corresponding to whether the customer conducts transactions same branch where the scanning device is located or different branches; data corresponding to frequency of branch visits by the customer; type of transactions previously conducted by the customer.

18. The system according to claim 11, wherein the SaaS allows users at the branch to connect to and use cloud-based applications over the Internet.

19. The system according to claim 11, wherein the processor is further configured to:
determine that the confidence score is less than the configurable threshold value;
receive additional verification documents from the customer;
train the AI/ML model with the additional verification documents to generate the confidence score; and
implement an identification validation portal to read the identification validation response generated by the SaaS from a cloud based datastore.

20. A non-transitory computer readable medium configured to store instructions for fraud verification across user identification formats, the instructions, when executed, cause a processor to perform the following:
scanning an identification document presented by a customer at a branch office by utilizing a scanning device;
generating, in response to scanning, a digital image of the identification document;
transmitting the digital image to a server;
calling a first application programing interface (API) to read the digital image from the server and request validation of the digital image with a second API for fraud verification across user identification formats;
calling the second API to transmit the digital image to a Software as a Service (SaaS);
receiving, by the second API, an identification validation response from the SaaS using existing data corresponding to the customer;
implementing an Artificial Intelligence (AI)/Machine Learning (ML) model to generate a confidence score based on predefined rules and historical data;
determining that the confidence score is equal to or more than a configurable threshold value; and
validating the digital image based on determining that the confidence score is equal to or more than the configurable threshold value.
